(19) United States
(12) Patent Application Publication
(10) Pub. No.: US 2025/0237282 A1
(43) Pub. Date: Jul. 24, 2025

(54) ENERGY-ABSORBING DEVICE

(71) Applicant: VALEO SYSTEMES THERMIQUES, Le Mesnil-Saint-Denis (FR)

(72) Inventors: Guillaume Gardere, Le Mesnil-Saint-Denis Cedex (FR); Sergio Da Costa Pito, Le Mesnil-Saint-Denis Cedex (FR); Emmanuel Rudloff, Le Mesnil-Saint-Denis Cedex (FR); Guolei Wang, Wuhan, Hubei (CN); Yongjian Ye, Wuhan, Hubei (CN)

(73) Assignee: VALEO SYSTEMES THERMIQUES, Le Mesnil-Saint-Denis (FR)

(21) Appl. No.: 18/698,363

(22) PCT Filed: Sep. 2, 2022
(86) PCT No.: PCT/EP2022/074527

§ 371 Date: Apr. 4, 2024

(30) Foreign Application Priority Data
Oct. 6, 2021 (FR) FR2110559

(51) Int. Cl. F16F 7/12

(52) U.S. Cl. CPC F16F 7/122; F16F 7/124; F16F 2224/0241; F16F 2226/04

(57) ABSTRACT

An energy-absorbing device for a vehicle is disclosed. The vehicle includes at least one core, composted of at least one energy-absorbing material, and a plastic structure molded onto the core in order to form an assembly in a single piece. The device includes at least one reinforcement part forming a local additional thickness of the core. The device also includes at least one mechanical retention element contributing towards holding the core and the at least one reinforcement part together.

The present invention relates to the field of energy-absorbing devices with which vehicles, in particular motor vehicles, are equipped. More particularly, the invention relates to an energy-absorbing device provided on an element to be protected of a vehicle, in particular a motor vehicle, the element to be protected being for example a body of the vehicle or an electric battery of the vehicle.

The energy-absorbing devices of motor vehicles are habitually installed between a bumper and a side member of said vehicle, or also in the vicinity of an electrical supply device of the vehicle, such as an electric battery. Whether they are positioned at the front bumper, the rear bumper or the electrical supply device of the motor vehicle, these energy-absorbing devices serve the purpose of absorbing at least partly the energy transferred to the vehicle during potential impacts with exterior objects.

More particularly, the energy-absorbing devices make it possible to prevent this energy being transmitted entirely to the side members of the vehicle or to the electric battery thereof, and thus to limit their deformation during these impacts, on the understanding that the replacement of a side member, which is an important structural element of the underbody of the vehicle or of the electric battery, would require costly operations.

In order to achieve the impact absorption performance levels required, it is known to make energy-absorbing devices of an appropriate composite material, with which there can be associated a support element which also forms a complementary absorber, and is made of plastic or any other similar material.

In this context, it may be desirable to add to the composite material a reinforcement part, which covers this composite material at least partly, and improves its capacities for resistance to impacts.

The relative positioning of this part made of composite material and this reinforcement part is however complex, since these two elements must for example be maintained in position relative to one another in order to undergo different machining steps, such as deformation by heating, in order to provide the composite material with an appropriate form, and an over-molding operation, in order to hold the position of the composite material well within the support formed by the plastic part.

The objective of the present invention is to eliminate this disadvantage by proposing an energy-absorbing device wherein the part made of composite material and the reinforcement part are joined to one another, such that the machining of the assembly thus formed is facilitated.

The main subject of the present invention is thus an energy-absorbing device for a vehicle comprising at least one core, composed of at least one energy-absorbing material, and a plastic structure molded onto the core in order to form an assembly in a single piece. According to the invention, the device comprises at least one reinforcement part forming a local additional thickness of the core, and the device also comprises at least one mechanical retention element contributing towards holding the core and the at least one reinforcement part together.

An energy-absorbing device of this type serves the purpose of absorbing at least partly the energy of an impact undergone by the vehicle. The core is a part of this energy-absorbing device, its composition providing it with properties of resistance to impacts making it possible for it to absorb the energy in the event of an impact. In order to take advantage of such properties, a plastic structure is molded onto this core, acting as a support part which makes possible the correct position of the core before the impact. The energy-absorbing device according to the invention also comprises at least one reinforcement part, which is designed to be interposed between the core and the plastic structure. By forming a local excess thickness of the core, a reinforcement part of this type makes it possible to improve further the resistance to impacts thereof. The core and the reinforcement part are rendered integral by means of one or a plurality of mechanical retention elements, this element or these elements providing a solution to the positioning problems of the prior art. More particularly, the reinforcement part must be positioned precisely so that it has the desired technical effect once the energy-absorbing device is on the vehicle, and the reinforcement part must maintain this theoretical position relative to the core until the over-molding of the plastic structure holds the position of the reinforcement part well. The mechanical retention part(s) specific to the invention make(s) it possible to ensure that the reinforcement part is in the required theoretical position at the moment of the aforementioned over-molding.

Other means for rendering the core and the reinforcement part integral could have been envisaged, such as adhesion. Adhesion is easier to implement, but requires a particular composition of the adhesive in order to adapt to the properties of the materials used to make the core and the reinforcement part, whereas, according to the invention, the implementation of mechanical retention means makes it possible to adapt to all types of composite materials, without moreover being sensitive to the heating conditions which the sub-assembly thus formed may undergo in order to be deformed and have a particular form on which the plastic structure is over-molded.

According to one characteristic of the invention, the energy-absorbing material comprises a plastic material and at least one consolidation material, in particular based on carbon fibers and/or glass fibers, incorporated in the plastic material.

An association of this type between plastic material and consolidation material forms a composite material which can absorb forces.

The plastic material can for example be a reinforced polypropylene, a polypropylene, a polycarbonate, a polyamide, or also a butylene polycarbonate/polyterephthalate mixture (PBT). In particular, the consolidation material can comprise fibers which extend in a longitudinal direction of the energy-absorbing device. Thus, the direction of extension of the fibers is substantially perpendicular to a direction of the forces sustained by the energy-absorbing device during an impact undergone by the motor vehicle. A characteristic of this type makes it possible to optimize the energy absorption by the device according to the invention by increasing its deformation capacity.

According to another characteristic of the invention, the core and the at least one reinforcement part have the form of a sheet. The sheets which form respectively the core and the at least one reinforcement part can have substantially similar thicknesses.

Sheets of this type are deformable, in particular by means of hot machining operations, such as to be able to adopt an optimized configuration for the absorption of the impacts, and in particular an undulating configuration. It is thus easier to give the core and the at least one reinforcement part a geometry with a form which is similar from one part to the other.

According to one characteristic of the invention, the core and the at least one reinforcement part are supported flat on one another, and have together a geometry with a common form.

According to another characteristic of the invention, the core has a geometry with a sinusoidal form.

It is understood that the core is deformed, for example by heating, such as to have an undulating form with a succession of crests, including at least one depression and at least one elevation, positioned alternating according to one of the dimensions of the core. A sinusoidal geometry of this type permits regular and progressive compression of the energy-absorbing device, and thus the best absorption of the forces during an impact.

According to one characteristic, the at least one reinforcement part is positioned so as to cover at least one of the crests of the sinusoidal form.

According to one characteristic of the invention, the device has an outer face which is designed to receive the impacts, and an inner face opposite which is designed to be positioned facing the element to be protected, with the sinusoidal form of the core comprising an alternation of outer crests, the top of which participates in defining the outer face, and inner crests, the top of which participates in defining the inner face, the at least one reinforcement part being positioned so as to cover one of the outer crests.

The outer face and the inner face are positioned at opposite ends of the energy-absorbing device. They can be discontinuous, with hollows being able to be formed between two adjacent tops of outer crests or inner crests. The at least one reinforcement part covers at least partly the end of the absorption device which is designed to receive the impacts, i.e. its outer face.

According to another characteristic of the invention, the at least one mechanical retention element is positioned spaced from the outer crest, covering which the at least one reinforcement part is positioned.

The at least one mechanical retention element makes it possible to render the core and the at least one reinforcement part integral, and for this purpose it has rigidity such that it is necessary to space the mechanical retention element from the outer face, and thus from the outer crests which participate in forming it, which face is designed to receive the impacts. More particularly, this mechanical retention element can be positioned in the vicinity of an inner crest adjacent to the outer crest which the at least one reinforcement part covers.

According to one characteristic of the invention, the at least one reinforcement part extends locally on the core of an inner crest to an adjacent inner crest, covering a single outer crest.

According to one characteristic of the invention, the at least one reinforcement part is in the form of a plate, supported against the core with larger dimensions, the plate being deformed in order to have a sinusoidal geometry common to that of the core, and wherein the at least one retention element is positioned on the periphery of this plate forming the reinforcement part.

In particular, the reinforcement part can originally have a rectangular flat form, which, in order to have a sinusoidal geometry, common to that of the core, is subsequently deformed by heating. Since the at least one reinforcement part and the core are designed to be rendered integral, the energy-absorbing device comprises at least one mechanical retention element, which in this case is positioned on the periphery of the at least one reinforcement part. “Periphery” means that this at least one retention element is positioned in the vicinity of the contours or edges of this reinforcement part.

According to one characteristic of the invention, a central part of the plate which forms the at least one reinforcement part is positioned so as to cover an outer crest of the geometry common to the core and to the at least one reinforcement part, said central part being without mechanical retention elements. Thus, as previously stated, the mechanical retention element(s) is/are not positioned on the crest, and do not form hard spots which can be detrimental during an impact undergone by the vehicle, and in particular for a third party vehicle which hits the vehicle.

The central part of at least one reinforcement part must in this case be considered as a part which is positioned spaced, in at least one direction of extension of the sheet originally forming the reinforcement part, from two edges of this reinforcement part participating in forming the periphery thereof.

Since this central part is positioned such as to cover an outer crest of the sinusoidal geometry common to the core and to the at least one reinforcement part, it is understood that the retention element(s) is/are positioned in the vicinity of the inner crests, such that the retention elements are as far as possible from the outer face which is designed to undergo first the impact undergone by the energy-absorbing device.

According to another characteristic, a plurality of reinforcement parts are positioned spaced from one another on the core, with at least one mechanical retention element being associated with each of the reinforcement parts, in order to keep it integral with the core, independently from the other reinforcement parts.

Each reinforcement part is thus rendered integral with the core by at least one mechanical retention element, with a mechanical retention element of this type participating in rendering integral a single reinforcement part.

According to one characteristic, the mechanical retention element comprises a rivet.

Advantageously, the rivet which forms the mechanical retention element is selected from among a standard rivet, a blind rivet, a rivet of the eyelet type, or also a counter-plate rivet.

These rivets represent mechanical retention elements which are easy to implement, in particular in a context where positioning on the periphery of the reinforcement part is required, both in order to avoid the presence of these hard spots at the outer face of the energy-absorbing device, and in order to permit efficient retention of the sub-assembly formed by the core and the reinforcement part in the vicinity of the contours of this sub-assembly, and to make it possible to avoid potential detachment before the plastic structure is over-molded.

According to one characteristic of the invention, the plastic structure comprises means for securing of the energy-absorbing device onto an element of the vehicle which is to be protected.

Securing means of this type participate in the stowing of the energy-absorbing device on the vehicle which it is designed to equip. The core and the reinforcement part also have securing means, for example recesses or notches. These securing means can receive securing elements, which, by passing through all of the core, the reinforcement part and the plastic structure, make it possible to secure the energy-absorbing device on the element of the vehicle which it is designed to protect. Securing of this type takes place at the inner face of the energy-absorbing device, which is the one facing the element to be protected.

The invention also concerns a vehicle, in particular a motor vehicle, comprising at least one element to be protected against impacts, and at least one energy-absorbing device as previously described.

An element of this type to be protected can for example be a body of the vehicle or an electric battery thereof. The energy-absorbing device is positioned facing the element to be protected, such that its inner face is facing this element to be protected, whereas its outer face designed to receive the impacts is opposite it.

The invention also covers a process for production of an energy-absorbing device as previously described, in which:
a sheet forming the core and at least one sheet forming locally on the core the at least one reinforcement part are positioned flat on one another;
the core and the at least one reinforcement part are assembled mechanically by mechanical retention elements;
the assembly thus formed is deformed, and a plastic structure is over-molded onto this deformed assembly, in order to form an assembly in a single piece.

An assembly of this type thus comprises a positioning step, an assembly step, and a deformation step. The positioning step consists of placing the sheet forming the at least one reinforcement part facing the core, such as to cover this core locally, and, more specifically, a portion of this core which is to be reinforced. The assembly step makes mechanical retention elements intervene, for example rivets, which participate in rendering the core and the at least one reinforcement part integral. The assembly thus formed is then deformed, for example by heating, and the plastic structure is over-molded onto this assembly in order to obtain the energy-absorbing device according to the invention. “Assembly in a single piece” means that the assembly formed by the core and the at least one reinforcement part on the one hand, and the plastic structure on the other hand, can not be separated without giving rise to deterioration of at least one of these elements. In other words, the plastic structure can not be separated from the core and the at least one reinforcement part without one or the other being damaged.

Other characteristics, details and advantages of the invention will become more apparent from reading the following description of embodiments provided by way of non-limiting indication, with reference to the appended drawings, in which:

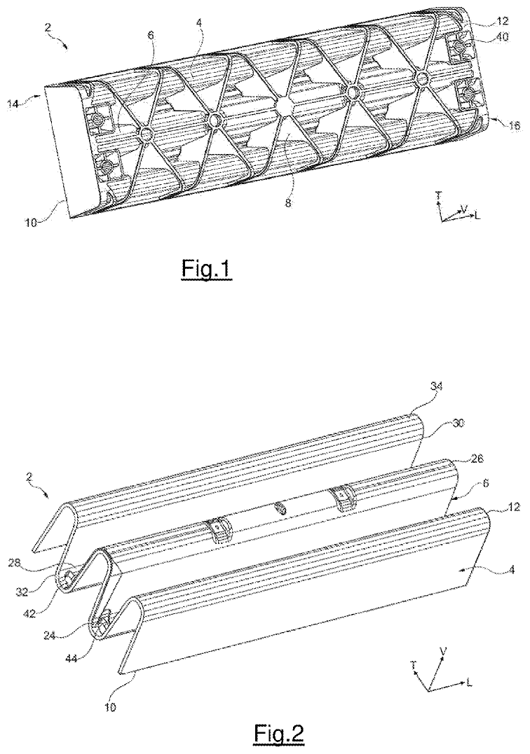

FIG. 1 illustrates, according to a view in perspective, an energy-absorbing device according to the invention, comprising in particular a core, associated with a reinforcement part and a plastic structure;

FIG. 2 is a view in perspective of a core and a reinforcement part of the energy-absorbing device of FIG. 1, in this case represented without the plastic structure;

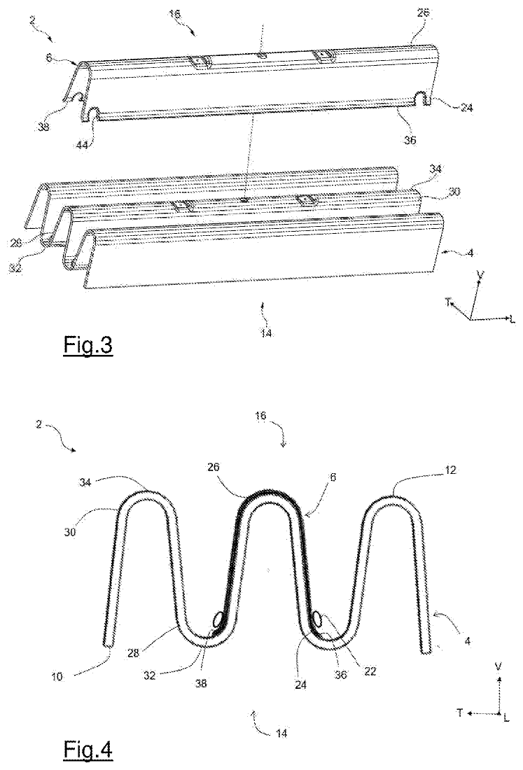

FIG. 3 is an exploded view of the core and the reinforcement part of FIG. 2;

FIG. 4 is a view in cross-section of the assembly of the core and the reinforcement part of FIG. 2, showing schematically mechanical retention elements rendering the core and the reinforcement part integral;

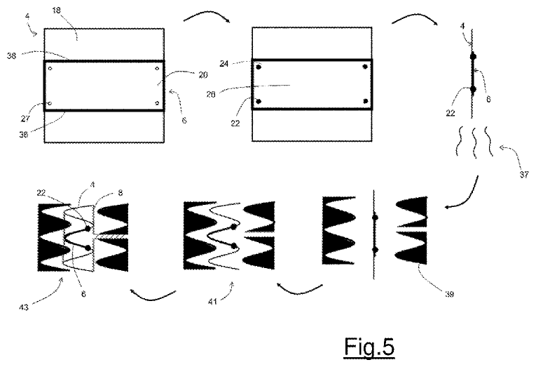

FIG. 5 is a schematic representation of a process for production of the energy-absorbing device of FIG. 1.

The characteristics, variants and different embodiments of the invention which will be described in particular hereinafter can be associated with one another in various combinations, provided that they are not incompatible or mutually exclusive. It will be possible, in particular, to conceive of variants of the invention that comprise only a selection of the characteristics described hereinafter, in isolation from the other characteristics described, if this selection of characteristics is sufficient to confer a technical advantage and/or to distinguish the invention from the prior art.

In the figures, elements that are common to multiple figures retain the same reference.

In the following detailed description, the terms “longitudinal”, “transverse” and “vertical” refer to the orientation of the energy-absorbing device according to the invention. A longitudinal direction corresponds to a main direction of extension of this energy-absorbing device, this longitudinal direction being parallel to the longitudinal axis L of a reference system L, V, T illustrated in the figures. A vertical direction corresponds to a direction of securing of the energy-absorbing device on the vehicle which it is designed to equip, and in particular on the element to be protected against impacts, this vertical direction being parallel to a vertical axis V of the reference system L, V, T, and this vertical axis V the being perpendicular to the longitudinal axis L. Finally, a transverse direction corresponds to a direction parallel to a transverse axis T of the reference system L, V, T, this transverse axis T being perpendicular to the longitudinal axis L and to the vertical axis V.

FIG. 1 thus illustrates schematically an energy-absorbing device 2 according to the invention, an energy absorbing device 2 of this type being designed to equip a vehicle, for example a motor vehicle. In this case, the energy-absorbing device 2 comprises a core 4, at least one reinforcement part 6 and a plastic structure 8.

The energy-absorbing device 2 is designed to protect the vehicle which it equips against shocks and impacts which the vehicle could undergo. For this purpose, positioned facing an element of the vehicle to be protected, not represented, an element of this type can in particular be a body of the vehicle or an electric battery thereof. The energy-absorbing device 2 extends mainly in a longitudinal direction, and in this case has a form which is inscribed mainly in a rectangular parallelepiped. The energy-absorbing device 2 comprises an inner face 10 and an outer face 12, opposite in a vertical direction, the inner face 10 being positioned at a first vertical end 14 of the energy-absorbing device 2, whereas the outer face 12 is positioned at a second vertical end 16. The inner face 10 and first vertical end 14 are facing the element to be protected, whereas the outer face 12 and second vertical end 16 are oriented such as to receive impacts.

The core 4 consists of an energy-absorbing material provided with properties of resistance to impacts. An energy-absorbing material of this type can for example be a composite material, formed by a consolidation material and a plastic material. This consolidation material, which is incorporated in the plastic material, can in particular comprise carbon fibers and/or glass fibers reinforcing the core locally. The fibers can be arranged such as to have a common direction of extension, and for example a direction parallel to the longitudinal direction in which the energy-absorbing device 2 mainly extends.

The core 4 and the at least one reinforcement part 6 have respectively, before any machining operation designed to deform them simultaneously, a form of a sheet 18 and 20, as shown in FIG. 5. These sheets 18 and 20 are substantially flat, and extend mainly on a longitudinal-transverse plane. They have a reduced thickness, a thickness of this type corresponding to their vertical dimension when they are flat as previously described. The sheet 18 corresponding to the core 4 can for example have a thickness of 2.5 mm, whereas the sheet 20 corresponding to the at least one reinforcement part 6 can have a thickness of approximately 1 mm.

The sheet 18 forming the core 4 has at least one dimension, distinct from the thickness, which is larger than the corresponding dimension of the sheet 20 forming the at least one reinforcement part 6. More particularly, the sheet 18 forming the core 4 has a transverse dimension larger than the corresponding transverse dimension of the sheet 20 forming the at least one reinforcement part 6, and this sheet 18 forming the core 4 has a longitudinal dimension equal to the corresponding longitudinal dimension of the sheet 20 forming the at least one reinforcement part 6.

According to the invention, the core 4 and the at least one reinforcement part 6 are supported flat on one another, and have together a geometry with a common form. It is understood in this case that the sheet 20 corresponding to the at least one reinforcement part 6 is positioned on the sheet 18 corresponding to the core 4, covering it at least partly. The geometry with a common form corresponds to a substantially flat geometry when the two parts are supported on one another before deformation of this sub-assembly, and the geometry with a common form corresponds to an undulating geometry when the two parts are against one another after deformation of this sub-assembly.

In fact, the sheet 18 corresponding to the core 4 and the sheet 20 corresponding to the at least one reinforcement part 6 are designed to be rendered integral and to undergo deformation simultaneously in order to form the energy-absorbing device 2, according to a production process which will be described hereinafter in relation with FIG. 5.

Before their deformation, the core and the at least one reinforcement part 6 are rendered integral by means of at least one mechanical retention device 22 according to the invention. It is understood that the energy-absorbing device 2 can comprise one mechanical retention element 22 or a plurality of mechanical retention elements 22, as is the case in the figures. Mechanical retention elements 22 of this type can example be in the form of rivets, in particular standard rivets, blind rivets, or also counter-plate rivets.

As illustrated in particular in FIGS. 4 and 5, the mechanical retention elements 22 are arranged on the energy-absorbing device 2 according to a particular arrangement. Thus, according to the invention, the mechanical retention elements 22 are positioned on the periphery 24 of a rectangular plate, which represents the original form of the sheet forming the at least one reinforcement part 6, with a central part 26 of this rectangular plate being on the other hand without such mechanical retention elements 22. It is understood that this periphery 24 corresponds to the contours or borders of the at least one reinforcement part 6, whereas the central part 26 is its portion which is spaced from these contours or borders, and is surrounded by them.

More particularly, in the example illustrated where the longitudinal dimensions of the core and the reinforcement part are the same, and where the transverse dimension of the reinforcement part is smaller than the corresponding transverse dimension of the core, such as to provide a partial cover, the central part of the reinforcement part extends spaced from the longitudinal edges, i.e. the edges of the reinforcement part which extend perpendicularly to the transverse direction.

The perforation of the core 4 and the at least one reinforcement part 6, necessary for the mechanical retention elements to render them integral, can alternatively be carried out directly when the mechanical retention elements 22 pass through their thickness when the elements are put into place, or by means of orifices 27 shown in FIG. 5, previously formed in the thickness of this core 4 and this at least one reinforcement part 6.

Once they have been rendered integral by means of the mechanical retention elements 22, the core 4 and the at least one reinforcement part 6 are deformed, in order to adopt a form specifically configured to absorb impacts. The core is thus deformed so as to have a geometry with a sinusoidal form constituted by an alternation of crests in successive depression and elevation, as shown in particular in FIGS. 2 to 4. A sinusoidal form of this type corresponds to undulation of the thickness of the core 4, and is oriented such that the amplitude of the sinusoidal form, between two successive crests, is oriented perpendicularly to the outer face which is designed to receive the impacts, in order to assist progressive compression of the energy-absorbing device 2 during an impact. The depressions correspond to inner crests 28 of the core 4, whereas the elevations correspond to outer crests 30 of this core 4. The inner crests 28 are in the vicinity of the inner face 10 and of the first vertical end 14, whereas the outer crests 30 are in the vicinity of the outer face 12 and the second vertical end 16. More particularly, the tops 32 of the inner crests 28 participate in defining the inner face 10, and the tops 34 of the outer crests 30 participate in delimiting the outer face 12. It is thus understood that, when the energy-absorbing device 2 is installed within a vehicle which it is designed to occupy, the inner crests 28 are facing the element to be protected, whereas the outer crests 30 are designed to receive the impacts.

According to the invention, the at least one reinforcement part 6 is positioned covering at least one of the crests of the sinusoidal form of the core 4. The at least one reinforcement part 6 thus forms a local excess thickness of the core 4, making it possible to reinforce its resistance to impacts. More particularly, and as shown in particular in FIGS. 2 to 4, the at least one reinforcement part 6 covers a single outer crest 30 of the core 4. The at least one reinforcement part 6 thus has a cross-section in the form of a “U”, seen on a plane perpendicular to the longitudinal direction of the core. Thus, it extends from the top 32 of a given inner crest 28 as far as the top 32 of an adjacent inner crest 28, by this means covering the top 34 of the outer crest 30 positioned between these two adjacent inner crests 28. Consequently, it is the central part 26 of the sheet that forms the at least one reinforcement part 6 which is positioned covering the outer crest 30 of the core 4, whereas the longitudinal edges forming the periphery 24 of this sheet are respectively in the vicinity of an inner crest 28.

The mechanical retention elements 22 are positioned spaced from the outer crest 30 which is covered by the at least one reinforcement part 6. These mechanical retention elements 22 can for example be positioned in the vicinity of the inner crests 28 adjacent to the covered outer crest 30. Since the central part 26 of the rectangular plate which forms the at least one reinforcement part 6 is without mechanical retention elements 22, it is understood that these mechanical retention elements 22 are situated on the inner face 10 rather than the outer face 12, and that the top 34 of the covered outer crest 30, with a top 34 of this type participating in forming this outer face 12, is also without mechanical retention elements 22.

Alternatively, the at least one reinforcement part 6 can cover a plurality of successive outer crests 30. In this case, the mechanical retention elements 22 could be positioned in the vicinity of the two inner crests 28 each situated at a transverse end 36 or 38 of the at least one reinforcement part 6, or also in the vicinity of each inner crest 28 covered by the at least one reinforcement part 6.

It is also possible to envisage an embodiment of the invention, not represented here, wherein a plurality of reinforcement parts 6 would be positioned spaced from one another on the core, with each of these reinforcement parts 6 then covering an outer crest 30 of the core. Each of the reinforcement parts 6 is in this case rendered integral with the core by means of one or a plurality of mechanical retention elements 22 specific to it, independently from the mechanical retention elements used for securing of the other reinforcement parts 6.

An energy-absorbing device 2 according to the invention can be obtained at the end of a production process illustrated in FIG. 5. A production process of this type can comprise at least three steps, including a positioning step, an assembly step and a deformation step.

The positioning step corresponds to the relative positioning of the sheet 18 forming the core 4 and of at least one sheet 20 forming the at least one reinforcement part 6 locally on this core 4. Positioning of this type is facilitated by an initial configuration of the core and the reinforcement part in the form of thin flat rectangular sheets extending in this initial configuration in two dimensions, to within the thickness. During this positioning step, the sheet 20 which forms the reinforcement part is positioned such as to be superimposed on a portion of the sheet 18 forming the core which is designed to become an outer crest of the undulating form of the core after deformation.

The core 4 and the at least one reinforcement part 6 are then pierced with the orifices 27 which can receive the mechanical retention elements 22. This piercing operation forms a sub-step of the assembly step, which is continued by insertion of the mechanical retention elements 22 in the orifices previously formed.

The orifices 27, and subsequently the mechanical retention elements 22, for example rivets, are positioned on the periphery 24 of the rectangular plate which forms the at least one reinforcement part 6, with the mechanical retention elements being deformed by means of an appropriate machine, in order to retain the core and the reinforcement part irreversibly.

The assembly thus made of the core 4 and the at least one reinforcement part 6 then undergoes a deformation step, during which the sheets 18 and 20 are deformed such as to have a geometry with a common sinusoidal form. A deformation step of this type can for example comprise a prior heating operation 37, at a temperature sufficient to make the energy-absorbing material malleable, followed by transfer to a mold 39 in which the core 4 and the at least one reinforcement part 6 are thermoformed during a forming operation 41. After deformation, the core 4 has the inner and outer crests previously described, and the at least one reinforcement part is formed on one of the outer crests, with the central part 26 of the at least one reinforcement part 6 which covers this outer crest 30 being without mechanical retention elements 22. The plastic material which forms the plastic structure 8 is then injected into the mold 39 during an over-molding step 43, and this plastic structure 8 is over-molded on the assembly formed by the core 4 and the at least one reinforcement part 6. This therefore provides an assembly in a single piece which corresponds to the energy-absorbing device 2, on the understanding that the assembly formed by the core 4 and the at least one reinforcement part 6 on the one hand, and the plastic structure 8 on the other hand can no longer be separated without giving rise to the deterioration of one or the other. It is understood that, within this assembly in a single piece, the at least one reinforcement part 6 is interposed between the core 4 and the plastic structure 8, as illustrated in FIG. 1.

The energy-absorbing device 2 thus formed can then be secured on the vehicle which it is designed to equip by means of securing means 40, which are shown in particular in FIG. 1. Securing means of this type, in this case tubes through which tightening screws can pass, make it possible to secure the energy-absorbing device 2 on the element to be protected of this vehicle. When the plastic structure 8 is covering both the core 4 and the at least one reinforcement part 6, the securing means 40 are facing complementary securing means 42 and 44 formed on this core 4 and this at least one reinforcement part 6 respectively. As illustrated in FIG. 2, these complementary securing means 42 and 44 can be in the form of through holes, as is the case for the complementary securing means 42 borne by the core 4, or also slots which open onto a longitudinal edge, as is the case for the complementary securing means 44 borne by the at least one reinforcement part 6. The particular arrangement of the securing means 40 and of the complementary securing means 42 and 44, facing one another, makes them able to receive securing elements such as tightening screws for example. These securing elements pass through the energy-absorbing device 2 from one side to another in the vertical direction, i.e. from its outer face 12 to its inner face 10. In other words, the securing elements are inserted through the plastic structure 8, the at least one reinforcement part 6, and the core 4, such as to be engaged in the element to be protected of the vehicle.

The present invention thus proposes an energy-absorbing device in which a part made of composite material and a reinforcement part are rendered integral with one another by one or a plurality of mechanical retention elements, thus facilitating the hold of this sub-assembly during the operation of production of the energy-absorbing device, irrespective of the type of material selected for the part made of composite material and the reinforcement part.

However, the present invention is not limited to the means and configurations described and illustrated here, and it also extends to any equivalent means and configurations, as well as to any technically operative combination of such means.

1. An energy-absorbing device for a vehicle,
the vehicle comprising at least one core, composed of at least one energy-absorbing material, and a plastic structure molded onto the core in order to form an assembly in a single piece,
wherein the energy-absorbing device comprises:
at least one reinforcement part forming a local additional thickness of the core, and
at least one mechanical retention element contributing towards holding the core and the at least one reinforcement part together.

2. The energy-absorbing device as claimed in claim 1,
wherein the energy-absorbing material comprises a plastic material and at least one consolidation material based on carbon fibers or glass fibers, incorporated in the plastic material.

3. The energy-absorbing device as claimed in claim 1,
wherein the core and the at least one reinforcement part are in the form of a sheet.

4. The energy-absorbing device as claimed in claim 3,
wherein the core and the at least one reinforcement part are supported flat on one another, and have together a geometry with a common form.

5. The energy-absorbing device as claimed in claim 4, wherein the core has a geometry with a sinusoidal form.

6. The energy-absorbing device as claimed in claim 5,
wherein the at least one reinforcement part is positioned so as to cover at least one of the crests of the sinusoidal form.

7. The energy-absorbing device as claimed in claim 6, the device further comprising:
an outer face which is configured to receive the impacts, and
an inner face opposite the outer face, which is configured to be positioned facing the element to be protected,
wherein the sinusoidal form of the core comprises:
an alternation of outer crests, the top of which participates in defining the outer face, and
inner crests, the top of which participates in defining the inner face,
wherein the at least one reinforcement part is positioned so as to cover one of the outer crests.

8. The energy-absorbing device as claimed in claim 7,
wherein the at least one mechanical retention element is positioned spaced from the outer crest,
wherein the at least one reinforcement part is positioned covering the outer crest.

9. The energy-absorbing device as claimed in claim 7,
wherein the at least one reinforcement part extends locally on the core of an inner crest, to an adjacent inner crest, covering a single outer crest.

10. The energy-absorbing device as claimed in claim 5,
wherein the at least one reinforcement part is in the form of a rectangular plate, supported against the core with larger dimensions,
wherein the rectangular plate is deformed in order to have a sinusoidal geometry common to that of the core, and
wherein the at least one retention element is positioned on the periphery of this reinforcement plate.

11. The energy-absorbing device as claimed in claim 10,
wherein a central part of the rectangular plate which forms the at least one reinforcement part is positioned covering an outer crest of the geometry common to the core and to the at least one reinforcement part,
wherein the central part without mechanical retention elements.

12. The energy-absorbing device as claimed in claim 1,
wherein a plurality of reinforcement parts are positioned spaced from one another on the core,
wherein at least one mechanical retention element is associated with each of the reinforcement parts, in order to keep it integral with the core, independently from the other reinforcement parts.

13. The energy-absorbing device as claimed in claim 1,
wherein the plastic structure comprises means for securing the energy-absorbing device on an element of the vehicle which is to be protected.

14. A vehicle comprising at least one element to be protected against impacts, and at least one energy-absorbing device as claimed in claim 1.

15. A process for production of an energy-absorbing device as claimed in claim 1, the process comprising:
positioning a sheet forming the core and at least one sheet forming locally on the core the at least one reinforcement part flat on one another;
assembling the core and the at least one reinforcement part mechanically by mechanical retention elements;
deforming the assembly, and
over-molding a plastic structure onto the deformed assembly, in order to form an assembly in a single piece.
